(19) United States
(12) Patent Application Publication
(10) Pub. No.: US 2013/0054632 A1
(43) Pub. Date: Feb. 28, 2013

(54) Caching Input Suggestions

(71) Applicants: Luuk van Dijk, Zurich (CH); Steffen Meschkat, Zurich (CH)

(72) Inventors: Luuk van Dijk, Zurich (CH); Steffen Meschkat, Zurich (CH)

(73) Assignee: GOOGLE INC., Mountain View, CA (US)

(21) Appl. No.: 13/221,655

(22) Filed: Aug. 30, 2011

(51) Int. Cl. G06F 17/30

(52) U.S. Cl. 707/767; 707/E17.005; 707/E17.017

(57) ABSTRACT

Methods, systems, and apparatus, including computer program products, for caching input suggestions are provided. In one aspect, a method includes receiving a first textual input in an input field from a user; sending the first textual input to a server before a user submits a request for results based on the first textual input; receiving a set of input suggestions from the server; storing the set of input suggestions in a local cache; displaying a first subset of input suggestions from the set of input suggestions to the user; receiving additional textual input from the user after the first textual input is sent to the server; analyzing the stored set of input suggestions to identify a new subset of input suggestions based on the additional textual input; and displaying the new subset of input suggestions.

### TECHNICAL FIELD

This specification relates to caching input suggestions.

### BACKGROUND

Conventional query services provide query suggestions as alternatives to input queries. For example, a conventional search engine can include a query input field that receives an input search query. In response to receiving the input search query, a conventional search service can provide alternative search query suggestions for the input search query. A user can select an alternative search query suggestion for use as a search query. Search engines that provide query suggestions can include application-specific query engines, such as map applications that return geographic information in response to queries received from a user. For example, query suggestions can be provided to correct apparent misspellings or other typographical errors, to complete partially input search queries, or to suggest queries that are likely to result in a better set of search results.

Generally, a user submits a search request at a client device, which is transmitted to a server hosting the search engine, where the submitted search query is analyzed. Based on the analysis, search results responsive to the query are identified by the search engine and returned to the client device. To provide alternative query suggestions to a user, an initial input query received from the user at the client device is transmitted to the server. In some cases, query suggestions can be provided based on a partial search query. Thus, as the user enters characters defining a search query, a partial search query can be transmitted to the server before the user submits the search query. In either case, the server can return alternative query suggestions and/or query completion suggestions to the client device based on the initial input of the user. The user may choose to use one of the suggested queries, enter additional input for the search query, or submit the search request without additional input.

### SUMMARY

This specification describes technologies relating to caching of input suggestions.

In general, one aspect of the subject matter described in this specification can be embodied in methods that include the actions of receiving a first textual input in an input field; sending the first textual input to a server before a user submits a request for results based on the first textual input; receiving a set of input suggestions from the server; storing the set of input suggestions in a local cache; displaying a first subset of input suggestions from the set of input suggestions to the user; receiving additional textual input from the user after the first textual input is sent to the server; analyzing the stored set of input suggestions to identify a new subset of input suggestions based on the additional textual input; and displaying the new subset of input suggestions. Other embodiments of this aspect include corresponding systems, apparatus, and computer program products.

These and other embodiments can optionally include one or more of the following features. A number of input suggestions in the first subset of input suggestions is determined based at least in part on a number of input suggestions in the set of input suggestions received from the server. A number of input suggestions in the new subset of input suggestions is the same as a number of input suggestions in the first subset of input suggestions. The first subset of input suggestions includes at least five different input suggestions. The first subset of input suggestions includes at most five different input suggestions. The first subset of input suggestions is displayed in a particular order based on an order of the input suggestions in the set of input suggestions received from the server. The new subset of input suggestions is displayed in a particular order based on the order of input suggestions in the stored set of input suggestions. The set of input suggestions includes suggestions for geographic locations based on at least one of historical data of requests for different geographic locations or a context associated with different geographic locations. The first textual input is sent to the server after a predetermined amount of time after receiving the first textual input.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an example architecture for a system that caches input suggestions for identifying additional input suggestions to display to a user.

FIG. 2 is a block diagram illustrating an example input suggestion aggregator.

FIG. 3 is an example process for caching input suggestions at a client device.

FIGS. 4A-4C are screenshots illustrating an example of a web page presenting an input field and input suggestions received from a search service.

Like reference numbers and designations in the various drawings indicate like elements.

### DETAILED DESCRIPTION

This specification describes technologies relating to caching of search query suggestions. For example, after a user enters textual input into an input field at a client device, the textual input is automatically transmitted to a server front-end for a search engine system before the user submits a search request containing the textual input to the search engine system. The search engine system returns a set of input suggestions based on the received textual input. After the input suggestions are returned to the client device from the server, the input suggestions are stored locally at the client device in a cache, and a subset of the received input suggestions may be displayed to the user. If the user enters additional input into the input field, the input suggestions stored in the cache at the client device can be searched for additional input suggestions for display to the user instead of transmitting the additional input back to the server to identify another set of input suggestions. In other words, if the stored input suggestions contain at least a minimum number of input suggestions that match the textual input received from the user, including the additional input, then those input suggestions may be displayed to the user instead of requesting additional input suggestions from the server. Accordingly, a round-trip request to and from the server for updated input suggestions can be saved by obtaining the input suggestions directly from a local cache at the client device.

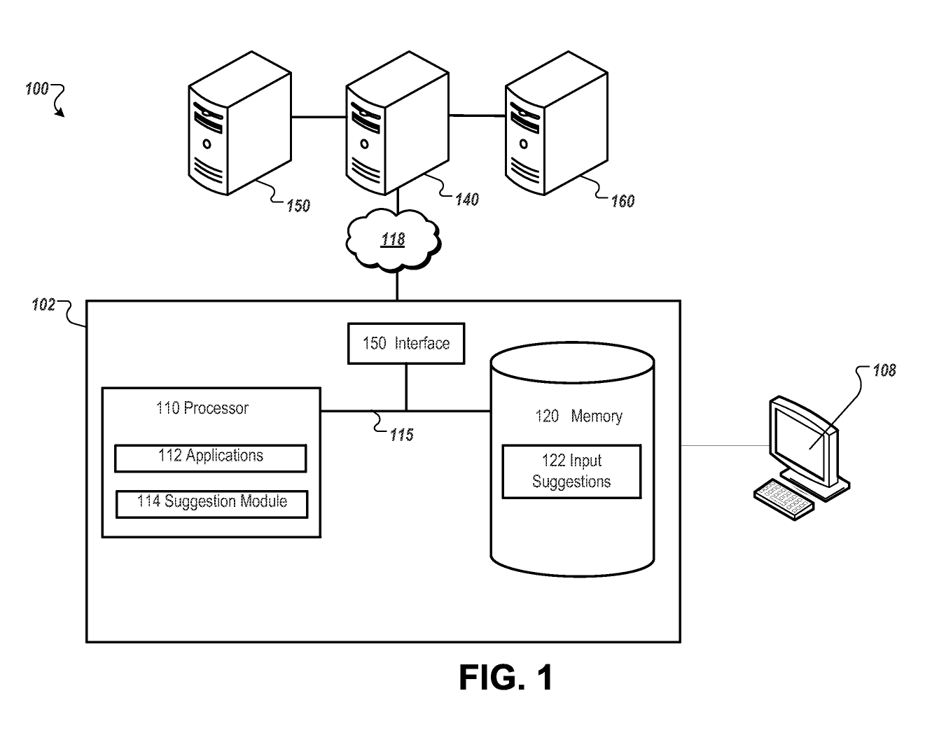

FIG. 1 is a block diagram illustrating an example architecture for a system 100 that caches input suggestions for identifying additional input suggestions to display to a user. The system 100 includes a computer 102 that may be used by a user interacting directly with the computer 102 through a display screen 108. In some instances, the computer 102 can be a personal computer, laptop, mobile device, PDA, tablet, or other computing device. The computer 102 includes a processor 110 that can execute programs, perform data manipulations, and control tasks in the computer 102. The processor 110 can execute programs such as computer applications 112. In some instances, computer applications 112 can include a web browser or other application configured to present a graphical user interface (GUI) to a user for accessing webpages and services hosted by external computers, such as server 140, that receive requests from the computer 102. As illustrated in FIG. 1, server 140 may be part of a server system that includes multiple front end servers 150 and 160, each of which may receive requests from the computer 102 or other client devices. A search and/or generation of input suggestions can be carried out on one of the servers 140, 150, 160 or using a search engine system, which may be distributed across many servers in a server farm or distributed across numerous server farms. The same server 140 or a different server can send the resulting input suggestions back to the client computer system 102.

Applications 112 may present input fields for receiving user input for submitting search requests to a general search engine, map-specific application, or other query-based service hosted at server 140. The input fields may be defined by the application 112 or defined in a web page or other document displayed by the application 112. The central processor 110 can communicate with other components of the computer 102 across a bus 115 that can include multiple busses, any of which may be parallel and/or serial busses. The computer 102 includes a memory 120, which can include volatile and/or non-volatile memory and is coupled with the communications bus 115. The computer 102 can also include one or more cache memories.

In some implementations, a suggestion module 114, e.g., a JavaScript script, installed on computer 102, included in application 112, or included in a web page or other document presented by the application 112 monitors input received in a search engine query input field associated with application 112 from a user. In some instances, the suggestion module 114 is implemented as plug in software for a web browser application installed on the computer 102. In some alternative implementations, the suggestion module 114 is installed on an intermediate server that receives requests from computer 102 for suggestions based on input from the user. The suggestion module 114 receives the input and automatically sends the input to a search service accessed through server 140, as the input is received. The suggestion module 114 may send inputs to the search service after a predetermined amount of time after the last character in the input was typed and before the user has submitted a request to perform a search using the typed input. The search service can include, for example, an index of popular search terms, corrections of common misspellings, and/or data for use in automatically completing words or terms based on partial user input. The index subsystem may be distributed across multiple servers, in some instances. The search service returns one or more input suggestions for searches to be performed by the particular search service or by another search service.

The suggestion module 114 can receive a set of input suggestions from the search service through server 140. The input suggestions are alternatives to the input, e.g., expansions, completions, or transliterations, that are distinct from the input. The suggestion module 114 can present the input suggestions to the user in real time, i.e., as the user is typing characters in the search engine query input field. For example, the suggestion module 114 can present a first group of input suggestions associated with a first character typed by the user, and present a second group of input suggestions associated with a sequence of the first character and a second character in response to the user typing the second character in the sequence.

The system 100 can also include one or more peripheral devices, and one or more controllers and/or adapters for providing interface functions. The peripheral devices can include a display device 108, such as a monitor or touch-screen display, to provide a graphical user interface to a user of computer 102. Graphical elements associated with applications 112, such as images, video, or text associated with input fields, search results, input suggestions, or webpages can be presented to the user through display device 108. The display device 108 can also present an interface for receiving requests submitted by a user of computer 102.

The peripheral devices can also include remote or local computer devices, such as desktop computers, laptop computers, and so on, each connected to the computer 102 using a network 118. The network 118 can be the Internet, a local area network (LAN), a wide area network (WAN), or any other network or combination thereof. The network 118 can also connect the computer 102 to one or more servers 140, with which computer 102 may communicate via messages or requests over network 118.

The computer 102 can further include a communication interface 150, which allows software and data to be transferred between the system 102 and server 140, external devices (e.g., peripheral devices), networks, information sources (e.g., Internet resources), and so on. The memory 120 of the computer 102 is operable to store data associated with applications 112, such as search results or input suggestions 122. In certain implementations, input suggestions 122 received from a search service through server 140 may be stored locally in memory 120. Accordingly, when a suggestion module 114 monitors user input to identify input suggestions for display to the user, the suggestion module 114 can search the input suggestions 122 stored in memory 120 for matching input suggestions instead of submitting the received input to the search service at server 140 for a new set of input suggestions.

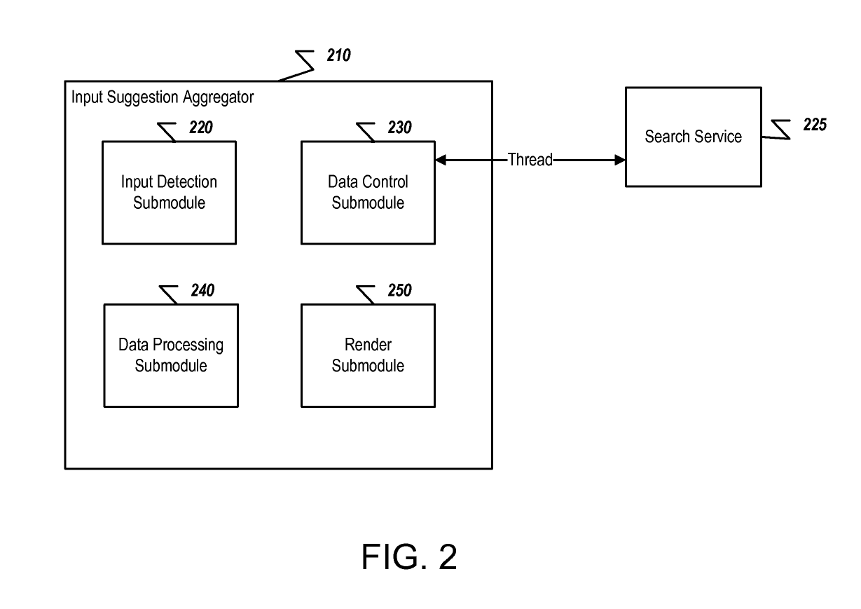

FIG. 2 is a block diagram illustrating an example input suggestion aggregator 210. The input suggestion aggregator 210 can include or be a part of the suggestion module 114 of FIG. 1. The input suggestion aggregator 210 includes an input detection submodule 220, a data control submodule 230, a data processing submodule 240, and a render submodule 250. The input detection submodule 220 detects input entered in an input field.

The data control submodule 230 communicates with one or more search services. In some implementations, the data control submodule 230 creates a thread for each of the one or more search services. In some implementations, the data control submodule 230 includes an event handler, e.g., an Ajax (Asynchronous JaysScript and XML) handler. The event handler generates calls to a communication engine, e.g., an Ajax engine, that sends asynchronous requests, e.g., XMLHttp requests, for input suggestions to the search services. In some implementations, the data control submodule 230 generates a call to the communication engine immediately after each token of a textual input, e.g., after each character of a first search query or each word of a first search query, is received at the search engine query input field. As a result, input suggestions can be provided to the user as the user types each token of the textual input. In some alternative implementations, the data control submodule 230 implements a delay, waiting a predetermined amount of time before automatically making the request to the two or more search services. The predetermined amount of time is specified in the input suggestion aggregator 210. The predetermined amount of time can be any amount of time (e.g., 0 ms, 150 ms) greater than or equal to 0. In practice, the predetermined amount of time typically falls in a range between 0 ms and 500 ms. In some implementations, the user can specify the predetermined amount of time by setting user preferences.

The data control submodule 230 receives different input suggestions from the one or more search services and sends the input suggestions to the data processing submodule 240. The data processing submodule 240 may store the input suggestions in a computer-readable memory, e.g., a local cache memory implemented in a local random access memory, to search the stored input suggestions to identify possible input suggestions responsive to multiple inputs received from a user. The render submodule 250, e.g., an Ajax render engine, renders the input suggestions for display to the user as the input suggestions are received from the search services or identified from the stored input suggestions.

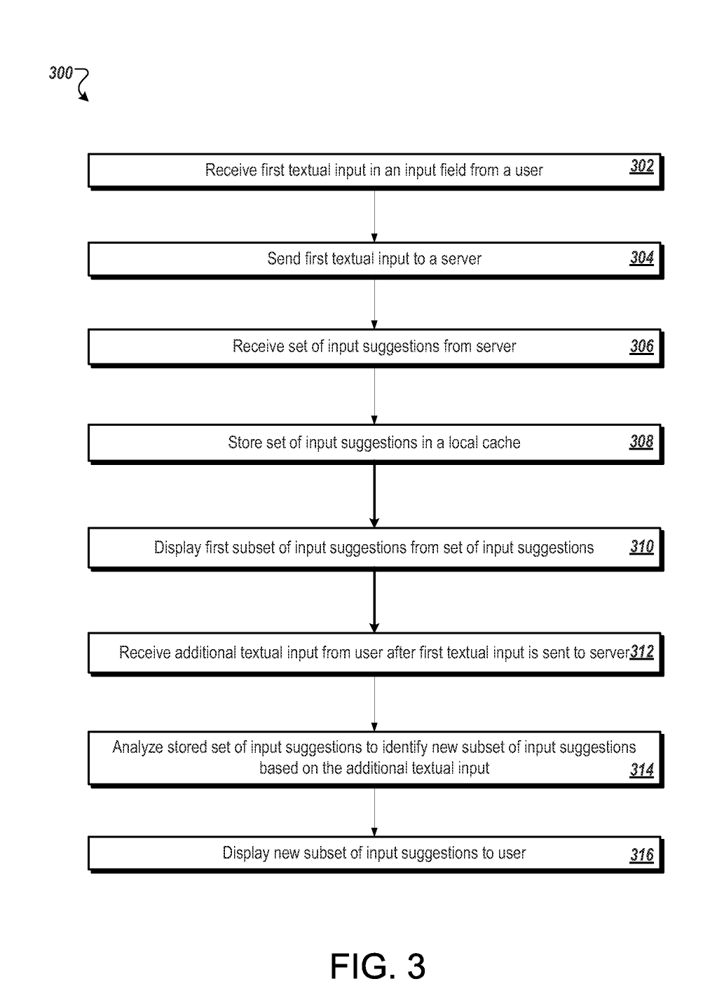

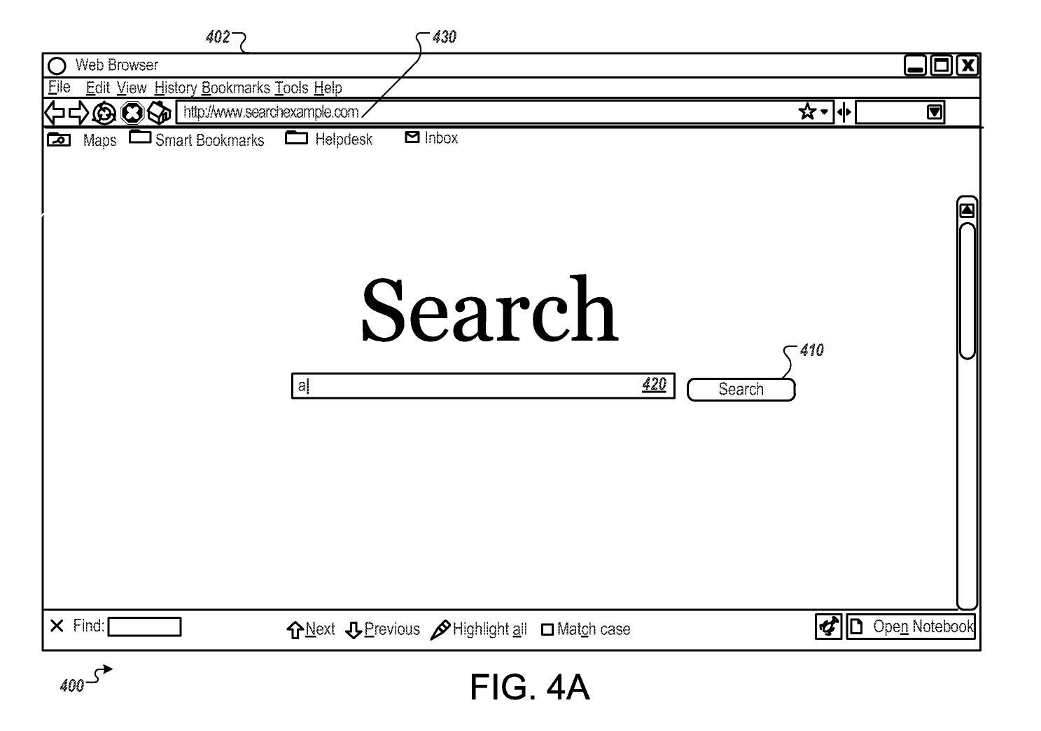

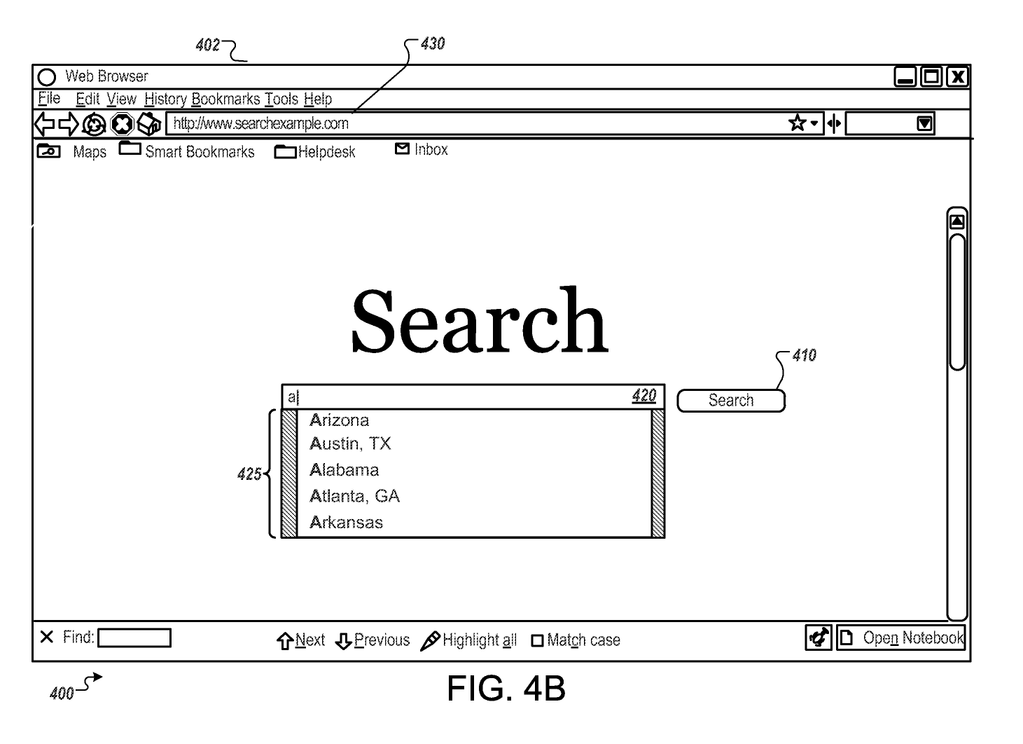

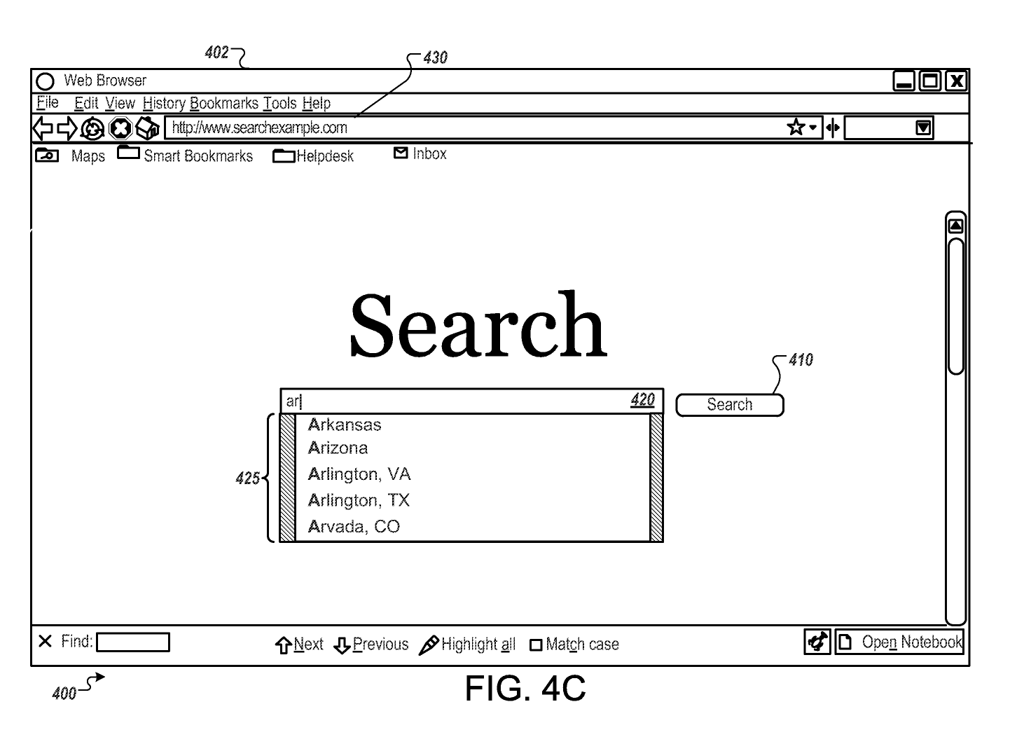

FIG. 3 is a flow chart illustrating an example process 300 for caching input suggestions locally at a client device. A first textual input in an input field is received from a user at 302. The textual input can include one or more characters typed into an input field, such as a field displayed on a search webpage or in a web browser or other application. For example, FIGS. 4A-4C illustrate example screenshots of an interface to a search service 430 hosted by a server 140. As illustrated in FIG. 4A, a web browser application 402 is displayed in a GUI at a client computer 102. A user may access different websites using the web browser 402, including search service 430. In some instances, search service 430 can include a general online search engine or context-specific search services such as map search services.

An input field 420 is displayed in the interface of the search service 430 that allows the user to type characters into the input field 420. The user can type an input string into input field 420 and submit the input string as a search query by selecting a “Search” object 410. The user's selection of the search object 410 is an example of a user's submission of a search request. Examples of a user submission of a search request can include the user clicking on the search object 410 with a pointer, typing in a particular input on a keyboard, or inputting a particular input on a touch-screen display. The search query is transmitted to a server system, where search results responsive to the search query are generated and returned by the search service 430. The search results may be received at the client computer 102 and displayed in the web browser 402.

The search service 430 can provide input suggestions after a user has typed characters into the input field 420 but before the user has submitted a search request, such as by selecting the search object 410. Accordingly, as shown in FIG. 3, after the first textual input is received in the input field 420, the first textual input received from the user is automatically sent to a server 140 by suggestion module 114 at 304 before additional input is entered. In certain implementations, a delay is implemented and the textual input is not automatically transmitted to the server 140 until a predetermined amount of time has passed. The predetermined amount of time is specified in the suggestion module 114. The predetermined amount of time can be any amount of time, e.g., 0 ms or 150 ms. In some implementations, the user can specify the predetermined amount of time by setting user preferences. For instance, in the example screenshot illustrated in FIG. 4A, a user has typed the character “a” into the input field 420. If the user pauses for more than a certain amount of time before typing the next character into the input field 320, the character “a” may be automatically sent to server 140 to retrieve input suggestions based on the received input. In other instances, the user may enter multiple characters in quick succession before pausing. Accordingly, the characters entered before the pause are submitted together as a string instead of submitting a request for input suggestions immediately after each character is entered.

The client computer 102 then receives a set of input suggestions from the server 140 at 306. The input suggestions are alternatives to the input, e.g., expansions, completions, transliterations, that are distinct from the input and are identified based on the likelihood that a particular input suggestion is a desired search query for the user. The likelihood may be based on, for example, data identifying a submission frequency of particular search queries, a submission frequency of particular search terms, a frequency of appearance of terms or phrases, an association of one term with another term (e.g., Vegas is frequently associated with Las), and/or other factors. The suggestion module 114 stores the set of input suggestions 122 in a computer readable memory 120, e.g., a local cache memory, at 308. In some implementations, the suggestion module 114 stores the textual input received from the user in the computer readable memory 120 and associates the input suggestions with the textual input. The set of input suggestions can be stored in the computer readable memory 120 so that, if additional input is received from the user, the stored input suggestions can be searched locally to identify particular input suggestions associated with the additional input received from the user without submitting another request for input suggestions from the server 140.

A first subset of input suggestions from the set of input suggestions is displayed at 310. The input suggestion module 114 displays the first subset of input suggestions in an interface element of the web browser showing the web page of the search service. In the example of FIG. 4B, the interface element 425 is a drop down menu showing first input suggestions that are expansions of “a”, e.g., “Arizona,” “Austin, Tex.,” “Alabama,” “Atlanta, Ga.,” and “Arkansas.” When a user selects one of the displayed input suggestions, the input suggestion module 114 sends the selection to the search service, and the search service responds in accordance with the selection.

The subset of input suggestions displayed to the user can be identified based on a ranking metric or other ordering system for the set of input suggestions received from the server 140. For example, a set of hundreds of input suggestions may be received from the server 140. The input suggestions may be arranged in a particular order when they are received at the client 102. Accordingly, each subset of input suggestions displayed to the user may consist of the highest-ordered input suggestions relative to other input suggestions in the currently available set of input suggestions. The ordering of input suggestions may be based on statistical data regarding frequency of searches containing different input suggestions. In other implementations, a particular ranking metric may be received from server 140 with the set of input suggestions providing an algorithm or guideline for determining which input suggestions to display in the first subset of input suggestions and what order to display the input suggestions.

For example, for map-specific search engines, input suggestions containing geographic locations may be identified and ordered for display based on the number or significance of landmarks and/or the population associated with a particular geographic location. In other words, the particular subset of input suggestions and the order of the input suggestions can be based on a combination of various metrics, including the frequency of previous searches containing a particular input suggestion and/or context-specific factors.

Further, the number of input suggestions included in the first subset of input suggestions may be a predetermined number. For example, five input suggestions may be included in the first subset of input suggestions. In some instances, each subsequent subset of input suggestions may also be limited to five input suggestions. In other words, five input suggestions are identified for each subset of input suggestions and displayed in response to textual input. In other implementations, the number of input suggestions displayed with each subset may vary depending on the context. For example, the number of input suggestions received from the server 140 may vary, and the number of input suggestions included in a subset for display to the user may depend on the number of input suggestions received. In some instances, the number of input suggestions displayed is a percentage of the total number of input suggestions received from a search service. Limits can also be placed on the number of input suggestions displayed, such as a maximum or minimum number of input suggestions displayed at one time to the user.

As depicted in the illustrated example in FIG. 4B, a list of the first subset of input suggestions from the set of input suggestions is displayed. In the present example, the search service provided through the web browser 402 is a map-specific search application. Accordingly, the subset of input suggestions 425 displayed below the input field 420 includes geographic locations that begin with the letter “a.” The displayed input suggestions 425 may be selected from the entire set of input suggestions received from the server 140 based on relevant factors or data as described above.

As shown in FIG. 3, additional textual input is then received from the user after the first textual input is sent to the server at 312. The additional textual input can include additional characters entered by the user in input field 420 to be appended to the first textual input received from the user as part of a query string. In the illustrated example depicted in FIG. 4C, the user has entered the character “r” after initially entering “a.” The suggestion module 114 may then determine appropriate input suggestions for the string “ar” for display to the user.

The set of input suggestions 122 that was previously stored in memory 120 can be searched and analyzed to identify a new subset of input suggestions based on the additional textual input at 314. In some instances, input suggestions that match the additional textual input may be found in the set of input suggestions 122 stored in memory 120. For example, the initial request for input suggestions may have resulted in a return of input suggestions from server 140. Within the input suggestions returned from server 140, there may be a subset of input suggestions (e.g., fifty input suggestions) that match the input received from the user, including the additional text “ar” typed into the input field by the user. If enough input suggestions are found in the stored set of input suggestions (e.g., at least the predetermined number of input suggestions for each subset of input suggestions), a new request for input suggestions does not need to be submitted to server 140. If, however, there are no input suggestions in the stored input suggestions that match the received textual input, or if there are less than the predetermined number of input suggestions for each subset of input suggestions, a request for additional input suggestions may need to be submitted to the server 140, although input suggestions that are available locally can be displayed and additional input suggestions can be appended once the additional suggestions are received.

The new subset of input suggestions is displayed to the user at 316. As illustrated in FIG. 4C, the new subset of input suggestions identified from the stored input suggestions in the present example include the terms “Arkansas,” “Arizona,” “Arlington, Va.,” “Arlington, Tex.,” and “Arvada, Colo.” In the present example, the new subset of input suggestions is included in the initial set of input suggestions received from the server 140 (at 306) and stored locally in memory 120. After the user entered the text “ar,” the new input suggestions are identified by the input suggestion module 114 from the stored input suggestions 122 as potential input suggestions for display to a user.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program, also known as a program, software, software application, script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A computer-implemented method performed by at least one processor for caching suggested entries, the method comprising:
receiving a first textual input in an input field from a user;
sending the first textual input to a server before the user submits a request for results based on the first textual input;
receiving a set of input suggestions from the server;
storing the set of input suggestions in a local cache;
displaying a first subset of input suggestions from the set of input suggestions to the user;
receiving additional textual input from the user after the first textual input is sent to the server;
analyzing the stored set of input suggestions to identify a new subset of input suggestions based on the additional textual input;
determining that a number of input suggestions in the new subset of input suggestions is greater than a predetermined number; and
displaying the new subset of input suggestions to the user.

2. The method of claim 1, wherein a number of input suggestions in the first subset of input suggestions is determined based at least in part on a number of input suggestions in the set of input suggestions received from the server.

3. The method of claim 1, wherein a number of input suggestions in the new subset of input suggestions is the same as a number of input suggestions in the first subset of input suggestions.

4. The method of claim 1, wherein the set of input suggestions are ranked according to frequency of use, and the new subset of input suggestions is selected based at least in part on the ranking.

5. The method of claim 1, wherein:
the textual input is received at a map search engine; and
the new subset are names of geographic places selected for display based on populations of the geographic places.

6. The method of claim 1, wherein the first subset of input suggestions is displayed in a particular order based on an order of the input suggestions in the set of input suggestions received from the server.

7. The method of claim 6, wherein the new subset of input suggestions is displayed in a particular order based on the order of input suggestions in the stored set of input suggestions.

8. The method of claim 1, wherein the set of input suggestions includes suggestions for geographic locations based on at least one of historical data of requests for different geographic locations or a context associated with different geographic locations.

9. The method of claim 1, wherein the first textual input is sent to the server after a predetermined amount of time after receiving the first textual input.

10. A system comprising:
one or more processors; and
a memory for storing a set of input suggestions, the memory storing instructions that when executed by the processors cause the processors to instantiate a suggestion module;
wherein the suggestion module is operable to send a first textual input to the server for input suggestions based on the first textual input, receive the set of input suggestions from the server, determine a first subset of the set of input suggestions to display based on the first textual input, analyze the set of input suggestions stored in the memory to determine a second subset of input suggestions based on additional textual input received after receiving the first textual input, and determine that a number of input suggestions in the second subset of input suggestions is greater than a predetermined number.

11. The system of claim 10, wherein a number of input suggestions in the first subset of input suggestions is determined based at least in part on a number of input suggestions in the set of input suggestions received from the server.

12. The system of claim 10, wherein the first textual input is sent to the server before receiving a request to submit a search query for results based on the first textual input.

13. The system of claim 10, wherein the suggestion module is further operable to display the first subset of the set of input suggestions in a particular order based on an order of input suggestions in the set of input suggestions received from the server.

14. The system of claim 13, wherein the second subset of input suggestions is displayed in a particular order based on the order of input suggestions in the stored set of input suggestions.

15. The system of claim 10, wherein the set of input suggestions includes suggestions for geographic locations based on at least one of historical data of requests for different geographic locations or a context associated with different geographic locations.

16. A computer program product tangibly embodied in a computer-readable storage medium, the computer program product including instructions that, when executed, perform the following operations:
receiving a first textual input in an input field from a user;
sending the first textual input to a server for input suggestions based on the first textual input;
receiving a set of input suggestions from the server;
storing the set of input suggestions in a memory;
determining a first subset of the set of input suggestions to display based on the first textual input;
analyzing the set of input suggestions stored in the memory to determine a second subset of input suggestions based on additional textual input received after receiving the first textual input, and
determine that a number of input suggestions in the second subset of input suggestions is greater than a predetermined number.

17. The computer program product of claim 16, wherein a number of input suggestions in the first subset of the set of input suggestions is determined based at least in part on a number of input suggestions in the set of input suggestions received from the server.

18. The computer program product of claim 16, wherein the first textual input is sent to the server before receiving a request to submit a search query for results based on the first textual input.

19. The computer program product of claim 16, wherein the set of input suggestions includes suggestions for geographic locations based on at least one of historical data of requests for different geographic locations or a context associated with different geographic locations.

20. The computer program product of claim 16, wherein the first textual input is sent to the server after a predetermined amount of time after receiving the first textual input.
